(19) United States
(12) Patent Application Publication
(10) Pub. No.: US 2007/0088649 A1
(43) Pub. Date: Apr. 19, 2007

(54) Manager selection

(75) Inventor: Roger Brown, Edinburgh (GB)

Correspondence Address: EDWARDS & ANGELL, LLP, P.O. BOX 55874, BOSTON, MA, 02205, US

(73) Assignee: Blacket Research Limited, Edinburgh (GB)

(21) Appl. No.: 11/546,845

(22) Filed: Oct. 12, 2006

Related U.S. Application Data
(60) Provisional application No. 60/726,277, filed on Oct. 13, 2005.

(51) Int. Cl. G06Q 40/00

(52) U.S. Cl. 705/36 R

(57) ABSTRACT

A method for measuring the performance of fund managers. The method comprises collecting quantitative performance data on the fund managers within a predefined service sector, comparing the quantitative performance of the fund managers against a chosen benchmark over a predefined period, calculating the probability of randomly selecting an outperforming fund manager from the group of fund managers and determining the probability of selecting a number of fund managers in a recommended shortlist who have outperformed the benchmark. The method is particularly applied in circumstances where a shortlist of fund managers has been created by a consultant for recommendation to fund trustees as it allows for an objective analysis of the consultant's recommendations.

### CROSS-REFERENCE TO RELATED APPLICATION

This application claims priority to U.S. Provisional Patent Application No. 60/726,277, filed Oct. 13, 2005, which is incorporated herein by reference.

### BACKGROUND OF THE INVENTION

1. Field of the Invention

The present technology relates to improvements in and relating to manager selection and in particular, but not exclusively, to the evaluation of advice provided by investment consultants in recommending a shortlist of fund managers to pension funds.

2. Background of the Related Art

Pension funds appoint trustees who have the responsibility of ensuring that the pension fund is run in compliance-with pensions law and to maximise the value of the fund to the beneficiaries. It is common for some or all of a pension fund to be managed externally and a number of companies offer this service. In most cases, the job of investing the money in the pension fund will be contracted to a firm of pension fund investment managers and the choice of which firm of fund managers is the responsibility of the trustees. In seeking to appoint fund managers, trustees typically choose fund managers on the basis of their potential performance.

In order to determine which fund managers are most likely to perform better than others, trustees engage the services of investment consultants to advise on the prospective performance of fund managers and they will draw up a shortlist of fund managers for consideration by the trustees based on the trustee's specific criteria. Therefore, the decision on which fund manager to appoint is greatly influenced by the analysis of fund managers provided by the investment consultant and presented on their shortlist to trustees.

There is currently no standard means of quantitatively measuring the quality of the advice provided by investment consultants in recommending shortlists to trustees.

A number of methods have been adopted in order to measure the consultant's skill in providing a short list. One approach adopted has been to create “notional portfolios” for each of the major asset groups such as UK equities and overseas equities. These notional portfolios are created by selecting managers and allocating a proportion of the portfolio to each of them. The returns on the notional portfolio are then calculated based on the performance of each manager and their weight in the portfolio. Managers are removed and replaced when the consultant's analysis concludes that they are no longer likely to beat the objective (benchmark). In some cases account is taken of the cost of changing managers.

While this approach may to some extent assist pension fund trustees in assessing the investment consultant's skill in selecting fund managers, there are significant issues that can render the information misleading.

For example, if a chief investment office resigns or a fund management group is taken over by, for example, a foreign bank, the consultants can (and do) remove that fund manager from their notional portfolio and replace them with another manager that they expect will beat their benchmark. As a result, by the end of a typical investment mandate's time horizon, the managers represented in the notional portfolio can bear no resemblance to those on the trustees' original shortlist.

Trustees do not have the same luxury as investment consultants to change the managers on the original shortlist in light of subsequent events. They must continue to work with decisions based on the shortlist.

In addition, the performance of an individual manager within the notional portfolio can have a disproportionate impact on the performance of the portfolio as a whole. In the extreme, a situation can arise where all but one of the managers in the portfolio underperformed the stated benchmark, but because of the stellar performance of the one manager that did outperform, the portfolio as a whole outperformed the benchmark. Again, this does not reflect reality when it comes to the consultant recommending a shortlist to a pension fund trustee—where the consultants' job is to recommend a shortlist of managers each of whom is expected to beat the benchmark over the life of the mandate.

In addition, the track records developed by investment consultants' notional portfolios are not directly comparable with each other as each firm of consultants uses different methodologies to calculate performance. These records may provide some insight to the consultants' ability to select managers, but cannot be of much value in selecting investment consultants until a comparable approach is adopted for the assessment of all consultants.

### SUMMARY OF THE INVENTION

It is an object of the present technology to provide a system and method for evaluating performance of the selection of fund managers.

It is a further object of the present technology to provide reliable and consistent information on the consultants ability to select outperforming managers for inclusion of a shortlist.

It is a further object of the present technology to improve the consistency and accountability of the selection of fund managers for inclusion on a short list.

In accordance with a first aspect of the present technology, there is provided a method for measuring the performance of fund managers, the method comprising the steps of:
collecting quantitative performance data on the fund managers within a predefined service sector;
comparing the quantitative performance of the fund managers against a chosen benchmark over a predefined period;
calculating the probability of randomly selecting an outperforming fund manager from the group of fund managers;
determining the probability of selecting a number of fund managers in a recommended shortlist who have outperformed the benchmark. Preferably the probability of selecting a number of fund managers who have outperformed the benchmark is given by a binomial expression.

Preferably the binomial expression is

$$Q = {\sum }_{i = S}^{N} P ( X = i ) ,$$

where P(X=i) is the binomial probability of i successes from a binomial distribution described by probability p and N trials.

Preferably, the binomial expression is a cumulative binomial algorithm.

Preferably, the method further comprises the step of calculating a score for a consultant. The consultant's score is used to quantify the valve of the advice provided by the consultant.

Preferably the consultant's score is given by the expression
C=100×(1−Q)−Δ
where Δ is a scaled estimate of the cumulative probability of the expected value of the binomial distribution. Preferably Δ is 50. Optionally Δ is estimated from the normal approximation to the binomial distribution.

Alternatively, the consultant's score can be derived from \hat{Q}, the probability of obtaining S or more outperforming managers from a sample of size N drawn from our universe when the binomial distribution is approximated with the continuous normal distribution.

More preferably, \hat{Q} is given by the equation

$$\hat{Q} = {\sum }_{i = S}^{N} \hat{P} ( X = i ) ,$$

where \hat{P}(X=i)is the probability of i successes calculated from the normal approximation to the binomial distribution with N trials and a probability, p, of success in each trial.

Preferably, the consultant's score, C, is given by
C=100×(1−\hat{Q})−50 .

Preferably, the method determines the extent to which added value changes over a predetermined period.

The application of statistics and data gathering provided in the present technology solves these fundamental problems and enables quantitative assessment of the consultants' advice on a consistent and comparable basis.

The present technology provides a system and method by which the value added from the original short list over the time horizon of the investment mandate, reflects what happens in reality rather than relying on notional, artificial scenarios.

This result can be achieved using binomial statistical methods.

Preferably, the service sector is a particular asset group (eg UK Equities). Preferably, the predefined period is the period of the pension fund mandate. Preferably, the group of service providers is the universe from which the measure of performance is calculated. This allows an assessment of the value added by the consultants' advice in recommending the shortlist.

It should be appreciated that the present invention can be implemented and utilized in numerous ways, including without limitation as a process, an apparatus, a system, a device, a method for applications now known and later developed or a computer readable medium. These and other unique features of the system disclosed herein will become more readily apparent from the following description and the accompanying drawings.

### BRIEF DESCRIPTION OF THE DRAWINGS

The present invention will now be described by way of example only with reference to the accompanying drawings which:

FIG. 1 is a flow chart showing the steps of a method in accordance with the present invention;

FIG. 2 shows the percentage of UK equity managers who have outperformed and a benchmark over predetermined periods;

FIG. 3 shows the excess return achieved by each of a group of fund managers; and

FIGS. 4 and 5 show the profile of a consultant's recommended shortlist in accordance with the invention.

### DETAILED DESCRIPTION OF PREFERRED EMBODIMENTS

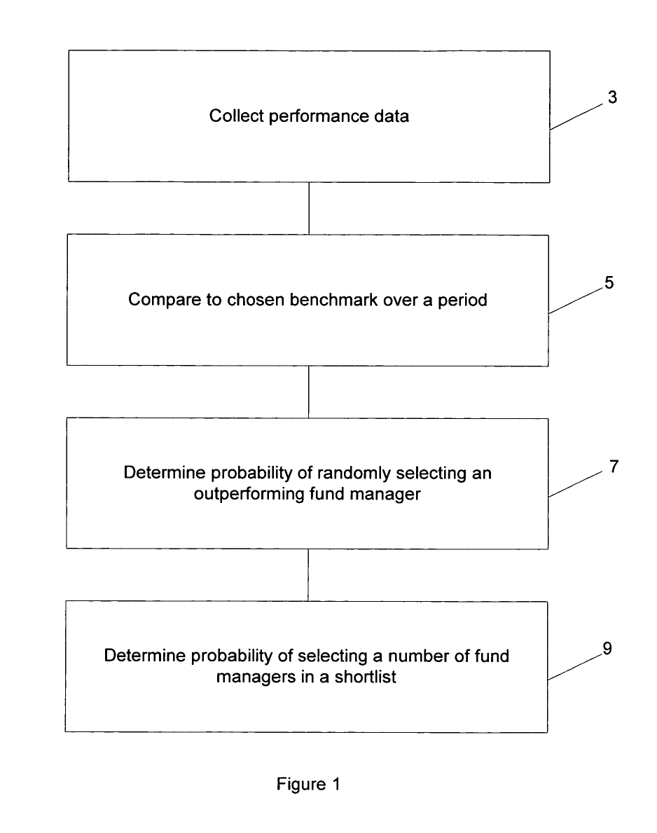

FIG. 1 shows an example of the method of the present technology 1 in which quantitative performance data on fund managers in UK Equities is collected 3. This data is compared 5 to a chosen benchmark over a predefined period, such as 3 years. The probability of randomly selecting an outperforming fund manager from the group of fund managers is then determined 7 and the probability of selecting a number of fund managers in a recommended shortlist who have outperformed the benchmark is determined 9.

In the context of the present technology, if, for example it was calculated that the probability of choosing an outperforming manager from the universe (group of service providers) was, 75% and 6 managers were randomly chosen then it would be expected that 4 (0.75×6) managers would have outperformed the benchmark. If when assessing the consultants' shortlist it was found that it contained 5 or 6 outperforming managers, then it could be concluded that the consultant had added value in their recommendation. If on the other hand there were only 3, 2, 1 or 0 outperforming managers in their shortlist then it could be concluded that the consultant has removed value.

This analysis may be applied to individual years, as well as to cumulative periods over the life of the mandate, although it is the cumulative binomial distribution that is used in the assessment of consultant skill. It can also be applied to all types of mandates (e.g., equities, property, bonds, etc), time horizons and shortlist sizes.

The consistent methodology and scoring also enables comparisons to be made across mandates and between investment consultants.

The approach taken when the method of the present technology is applied provides an assessment of whether:
the consultant's advice was better than a random selection of managers;
if value was added, how rapidly did it decay over the life of the mandate; and
was the expertise of the consultant in selecting managers confined to specific areas (eg UK equities, bonds, overseas equities)?

Depending on the trustees requirements, consultants either a shortlist of specific pooled funds run by fund managers, or a shortlist of investment management companies who they believe are capable of managing a fund that can beat the required benchmark is recommended. The Global Investment Performance Standard (GIPS) composite fund or a compatible pooled fund run by each investment management company is used in the analysis of performance of both the universe of companies within the asset group and the companies in the shortlist as appropriate.

### EXAMPLE 1

Investment Mandate: UK Equity Manager
Start Date: 1 January 2000
Benchmark: FTSE All Share Index +0%
Shortlist Manager A
   Manager B
   Manager C
   Manager D
   Manager E
   Manager F

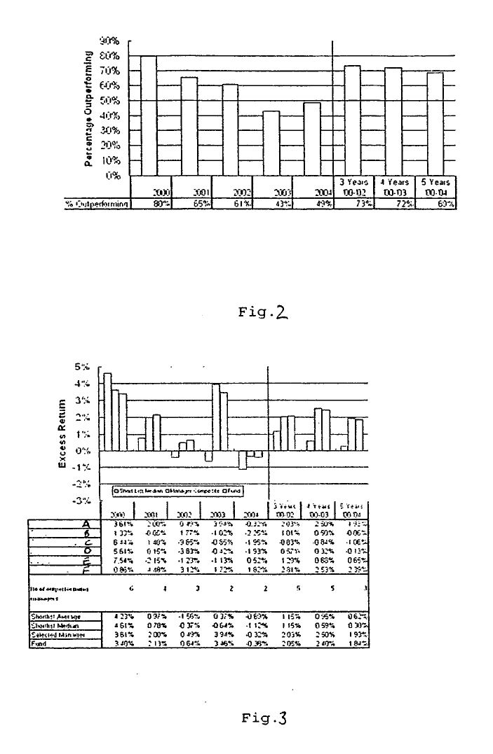

The chart of FIG. 2 shows the percentage of UK equity managers who outperformed the benchmark over individual and cumulative periods since the start of the mandate.

The chart of FIG. 3 shows the excess return (relative to the benchmark) achieved by each of the fund managers within the consultant's recommended shortlist. From this an assessment of how many outperformed the benchmark can be obtained. This data is provided in the row entitled “No. of outperforming managers”.

The probability of the consultant recommending outperforming fund managers, and whether or not the consultant has added or removed value in their selection is then calculated using this information.

For a given shortlist of length N containing S outperforming managers the score for the consultant is calculated as follows. The probability, p, of choosing one outperforming manager from the universe has been calculated. From this the probability, Q, of obtaining S or more outperforming managers from a sample of N drawn from our universe can be calculated from.

$$Q = {\sum }_{i = S}^{N} P ( X = i ) ,$$

Where P(X=i) is the binomial probability of i successes from a binomial distribution described by probability p and N trials.

The consultant's score, C, is then obtained from
C=100×(1−Q)−Δ
where Δ is a scaled estimate of the cumulative probability of the expected value of the binomial distribution. Δ is generally taken to be 50 however for certain shortlists it may be estimated from, for example, the normal approximation to the binominal distribution.

Alternatively, for small shortlists where the discrete nature of the binomial distribution leads to wide variations in scores, the consultant's score can be derived from \hat{Q}, the probability of obtaining S or more outperforming managers from a sample of size N drawn from our universe when we approximate the appropriate binomial distribution with the continuous normal distribution. More precisely,

$$\hat{Q} = {\sum }_{i = S}^{N} \hat{P} ( X = i ) ,$$

where P(X=i)is the probability of i successes calculated from the normal approximation to the binomial distribution with N trials and a probability, p, of success in each trial. The consultant's score, C, is given by
C=100×(1−\hat{Q})−50.

This yields scores in the range −50 to +50. Scores close to +50 suggest that the probability Q of selecting S outperforming managers is small and therefore the consultant has shown skill in his selection.

Alternatively scores close to −50 suggest that the probability Q of selecting S outperforming managers is high and therefore the consultant has removed value in the selection process as any random selection of N managers from the universe is likely to yield more than S outperforming managers.

Using this methodology, the consultant's score and the quality of the consultant's advice is shown in a chart.

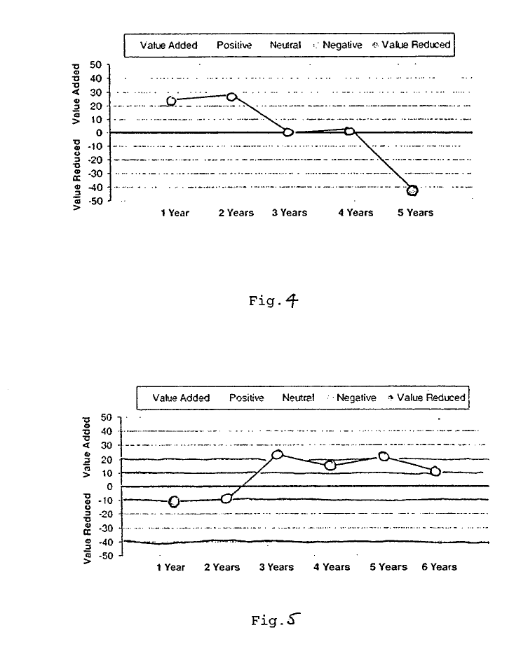

The chart of FIG. 4 shows the profile of the consultant's recommended shortlist in example 1 over the life of the mandate on a cumulative basis.

In this case, it can be seen that the consultant added value in the early years, but that this decayed over the life of the mandate to the point where value was actually removed by the consultant after 5 years, suggesting that the pension fund trustee would probably have had more success choosing 6 managers for their shortlist at random.

### EXAMPLE 2

For this second example, the analysis is also based upon UK Equities with a benchmark of FTSE all Share Index +0%. The short listed managers have been changed, the number of managers in the shortlist has been reduced from 6 to 4, and the time period of the mandate has been altered:
Investment Mandate: UK Equity Manager
Start Date: 1 January 1999
Benchmark: FTSE All Share Index +0%
Shortlist: Manager G
   Manager H
   Manager I
   Manager J

The following table shows calculations and the factors that are taken into account in assessing the quality of the consultant's advice and the score using the same methodology explained in Example 1 above.

| | 1 Year | 2 Years | 3 Years | 4 Years | 5 Years | 6 Years |
|---|---|---|---|---|---|---|
| Probabilty of OutPerform | 0.45 | 0.666667 | 0.717949 | 0.769231 | 0.72973 | 0.787879 |
| No of managers on short list | 2 | 3 | 4 | 4 | 4 | 4 |
| who outperformed | | | | | | |
| Consultant Score | −10.9019 | −9.25926 | 23.43109 | 14.98722 | 21.64379 | 11.46657 |

This results in the consultant profile shown in FIG. 5. In this example, it can be seen that the quality of the shortlist improved during the first 3 years (1999-2001) and maintained its value over the remaining lifetime of the mandate. After 6 years, the consultant can be said to have added some value in their selection of managers for the shortlist.

These scores, charts and results are presented in a report to the pension fund trustees and show the quality of the advice they have received from their investment consultant in selecting a shortlist of managers for a given mandate. From this, the trustee (and consultant) can pinpoint weaknesses in their decision making process and take any necessary action. In time, and with a sufficient number of evaluations, the results achieved by each of the main investment consultants may be compared to identify those that add or remove value from the process across all mandates and for specific types of mandate. In time, this methodology may be used as a basis for calculating performance related fees for investment consultants.

Improvements and modifications may be incorporated herein without deviating from the scope of the invention.

1. A method for measuring the performance of fund managers, the method comprising the steps of:
collecting quantitative performance data on the fund managers within a predefined service sector;
comparing the quantitative performance of the fund managers against a chosen benchmark over a predefined period;
calculating the probability of randomly selecting an outperforming fund manager from the group of fund managers;
determining the probability of selecting a number of fund managers in a recommended shortlist who have outperformed the benchmark.

2. A method as claimed in claim 1 wherein, the probability of selecting a number of fund managers who have outperformed the benchmark is given by a binomial expression.

3. A method as claimed in claim 2 wherein, the binomial expression is
$$Q = {\sum }_{i = S}^{N} P ( X = i ) ,$$
where P(X=i) is the binomial probability of i successes from a binomial distribution described by probability p and N trials.

4. A method as claimed in claim 2 wherein, the binomial expression is a cumulative binomial algorithm.

5. A method as claimed in claim 1 wherein, the method further comprises the step of calculating a score for a consultant.

6. A method as claimed in claim 5 wherein the consultant's score is given by the expression
C=100×(1−Q)−Δ
where Δ is a scaled estimate of the cumulative probability of the expected value of the binomial distribution.

7. A method as claimed in claim 6 wherein, Δ is 50

8. A method as claimed in claim 6 wherein, Δ is estimated from the normal approximation to the binomial distribution.

9. A method as claimed in claim 5 wherein, the consultant's score can be derived from \hat{Q}, the probability of obtaining S or more outperforming managers from a sample of size N drawn from our universe when the binomial distribution is approximated with the continuous normal distribution.

10. A method as claimed in claim 9 wherein, \hat{Q} is given by the equation
$$\hat{Q} = {\sum }_{i = S}^{N} \hat{P} ( X = i ) ,$$
where \hat{P}(X=i)is the probability of i successes calculated from the normal approximation to the binomial distribution with N trials and a probability, p, of success in each trial.

11. A method as claimed in claim 10 wherein, the consultant's score, C, is given by
C=100×( 1−\hat{Q})−50.

12. A method as claimed in claim 1 wherein, the extent to which added value changes over a predetermined period is determined.

13. A method as claimed in claim 1 wherein the service sector is a particular asset group.

14. A method as claimed in claim 1 wherein, the predefined period is the period of a pension fund mandate.
